(19) United States
(12) Patent Application Publication
(10) Pub. No.: US 2025/0229443 A1
(43) Pub. Date: Jul. 17, 2025

(54) EXTREME ENVIRONMENT ROBOT AND METHOD FOR USE THEREOF

(71) Applicant: The Governors of the University of Alberta, Edmonton (CA)

(72) Inventors: Rafiq Ahmad, Edmonton (CA); Misha Afaq, Edmonton (CA)

(73) Assignee: The Governors of the University of Alberta, Edmonton (CA)

(21) Appl. No.: 19/019,029

(22) Filed: Jan. 13, 2025

Related U.S. Application Data
(60) Provisional application No. 63/620,789, filed on Jan. 13, 2024.

(51) Int. Cl. B25J 19/00; B25J 5/00; B25J 9/16; B25J 19/02

(52) U.S. Cl. CPC B25J 19/0054; B25J 5/005; B25J 9/1674; B25J 19/02

(57) ABSTRACT

A mobile inspection robot for extreme environment conditions is provided. The robot includes a main body housing defining at least one through opening therein. A temperature sensor is positioned within the main body housing to determine an internal temperature within the main body housing. A thermal opening mechanism is positioned within the main body housing and selectively opens and closes the at least one through opening in the main body housing. A fuzzy logic temperature control system controls the thermal opening mechanism to adjust the internal temperature of the robot by selectively heating or cooling internal air within the main body housing to a preselected temperature based on feedback from the temperature sensor. A method of extreme environment mobile inspection is also provided based on the operation of the robot in the extreme environment. Information about the extreme environment is communicated from the robot to a location remote therefrom.

### RELATED APPLICATIONS

This application is a non-provisional application that claims priority benefit of U.S. Provisional Application Ser. No. 63/620,789 filed Jan. 13, 2024; the contents of which are hereby incorporated by reference.

### FIELD OF THE INVENTION

The present invention relates to an inspection robot, and more particularly to an extreme environment inspection robot for inspection of oil and gas facilities or infrastructure located in inhospitable environments with extreme how and cold conditions.

### BACKGROUND OF THE INVENTION

Inspection robots can be deployed in a wide range of environments that exhibit an abundance of hazards and extreme conditions. Exemplary environments include those with chemicals and radiation present, strong winds, extreme weather conditions, forest fires. explosives, high pressure environments, high temperature environments, fluid flows, deep sea conditions, space environments, and areas infected with dangerous micro-organisms or diseases. The oil and gas industry is the largest among these, with a wide range of challenging on-shore and off-shore inspection environments that demand automation. Moreover, most onshore environments necessitate direct human involvement at various levels of the business, from oil and gas energy product extraction to distribution. Robotic technology currently used in the oil and gas onshore industries faces significant drawbacks in terms of the lack of autonomy, reliability, and robustness of operation and as a result, is highly supervised. Moreover, oil and gas facilities are mostly located in inhospitable environments with extreme hot and cold conditions, such as low temperatures that can routine dip below −40° C. in polar regions such northern Canada. The pipes and tanks for fluid storage and distribution and the vehicles carrying the oil and gas supply require regular inspection and maintenance as these objects are subjected to high pressure, temperature, vibration, and humidity which can cause irreparable damage.

Several robotic technologies have been developed and implemented to deal with inspection related to damage detection, like cracks, corrosion, pitting, thermal cycling, and shock loading etc., on the surface of objects like pipelines, tanks, and infrastructures. However, insufficient robotic technologies exist that can perform damage-related inspections in extreme outdoor weather conditions, specifically in harsh winter environments with snow-clad terrains and low temperatures.

Thus, there exists a need for an inspection robot configured to navigate over various kinds of outdoor terrains, move in tight spaces, and inspect various objects such as pipelines, vehicles, infrastructure, plants, and equipment, and otherwise operate in extreme temperatures ranging from −40° C. to +60° C. for safe, reliable, and autonomous operation.

### SUMMARY OF THE INVENTION

A mobile inspection robot for extreme environment conditions is provided. The robot includes a main body housing defining at least one through opening therein. A temperature sensor is positioned within the main body housing and configured to determine an internal temperature within the main body housing. A thermal opening mechanism is positioned within the main body housing and configured to selectively open and close the at least one through opening in the main body housing. A fuzzy logic temperature control system is configured to control the thermal opening mechanism to adjust the internal temperature of the robot by selectively heating or cooling internal air within the main body housing to a preselected temperature based on feedback from the temperature sensor.

A method of extreme environment mobile inspection is also provided based on the operation of the robot in the extreme environment. Information about the extreme environment is communicated from the robot to a location remote therefrom.

### BRIEF DESCRIPTION OF THE DRAWINGS

The present invention is further detailed with respect to the following figures that depict various aspects of the present invention.

FIG. 1 is a perspective view of a mobile robot according to certain embodiments of the present invention with a robot arm and tracks;

FIG. 2 is a perspective view of a mobile robot according to other embodiments of the present invention with a PTZ mechanism and tracks;

FIG. 3 is a perspective view of a mobile robot according to other embodiments of the present invention with robot arm and omni-wheels;

FIG. 4 is a perspective view of a mobile robot according to other embodiments of the present invention with a PTZ mechanism and omni-wheels;

FIGS. 5A and 5B show an isometric view and a side view, respectively of a robot body for heating and cooling according to certain embodiments of the present invention;

FIG. 6A shows a cut-away view of a robot body according to certain embodiments of the present invention showing a thermal opening mechanism therein;

FIG. 6B is a perspective view of the thermal opening mechanism of FIG. 6A;

FIG. 7 is a spur gear FBD with forces exerted on it by the worm gear;

FIG. 8 is a thermal opening shaft FBD with forces and torque due to bearings, gears, and the plate; and

FIGS. 9A and 9B show thermal opening shaft shear force diagrams (SFD) and bending moment diagrams (BMD) in the x-y plane and the x-z plane, respectively.

### DETAILED DESCRIPTION OF THE INVENTION

The present invention has utility as an extreme environment robot for inspection of infrastructure in inhospitable environments and configured to navigate over various kinds of outdoor terrains, move in tight spaces, and inspect various objects such as pipelines, vehicles, infrastructure, plants, and equipment, and operate in extreme temperatures ranging from −40° C. to 60° C. for safe, reliable, and autonomous operation.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

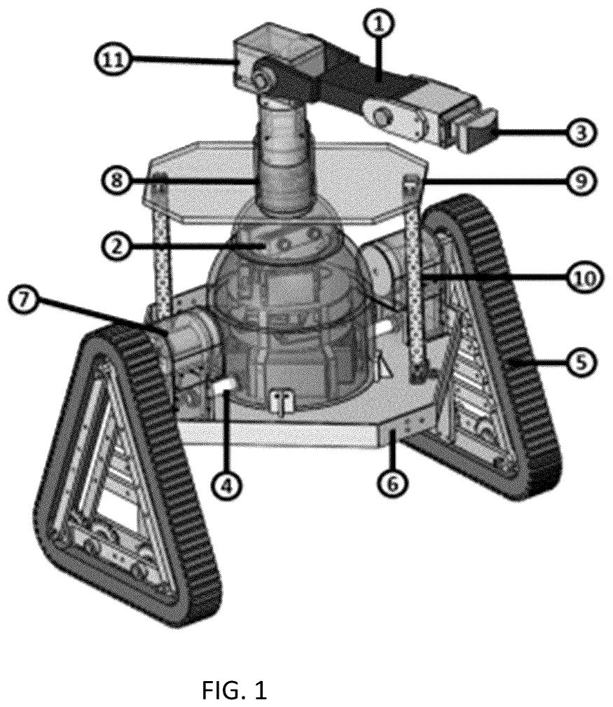

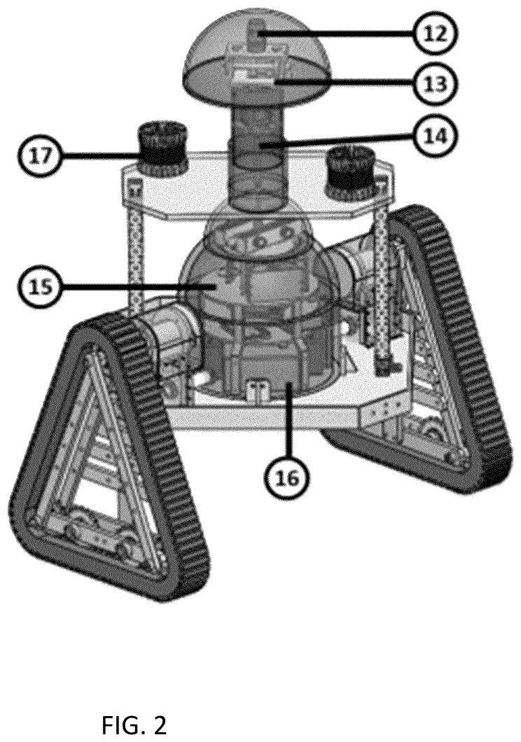

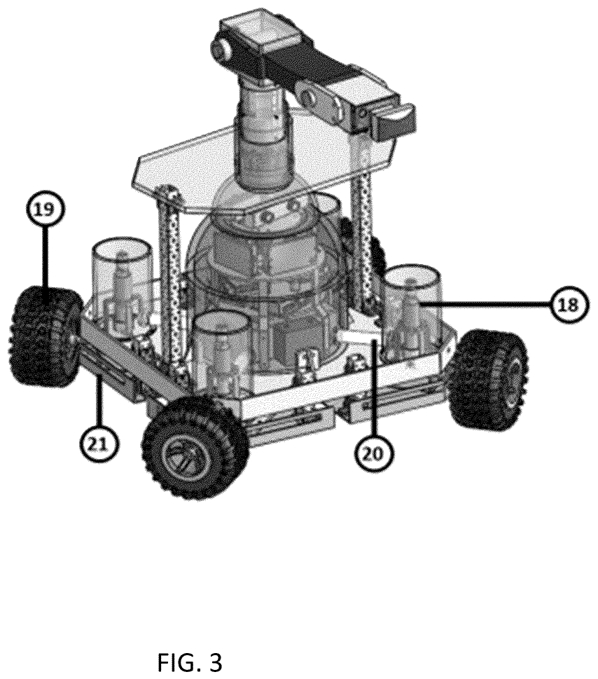

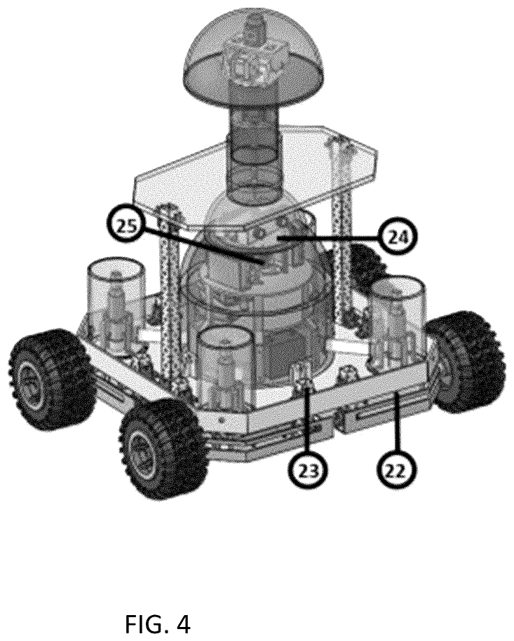

According to embodiments, a mobile inspection robot is a modular design with a base frame and main body to which various combinations of a robot arm, tracks, omni-wheels, camera PTZ mechanism etc. are interchangeably added, as shown in FIGS. 1, 2, 3, and 4. The main body part houses all of the critical electrical components such as batteries, embedded computer, navigation cameras, and heating/cooling devices. According to some inventive embodiments, the main body is positioned in the center of the robot. According to embodiments, the main body is cylindrical.

Table I lists the components of the robot and subassemblies thereof, showing a reference number from FIGS. 1-4 and provides corresponding name, description, and possible material of the component.

TABLE I
components of the robot according to embodiments of the present invention.

| Number | Name | Description | Material |
|---|---|---|---|
| \textcircled{1} | Robot arm | The robot arm can rotate more than | Robot arm parts: |
| | | 90 degrees on each side from the | End-effector |
| | | vertical position. An NDT sensor, | and brackets |
| | | such as an ultrasonic probe or | (Aluminum 6061) |
| | | camera, can be attached to the end- | Arm (Hexcel |
| | | effector. The orientation of the end- | AS4C carbon |
| | | effector with the sensor can be | fiber) |
| | | adjusted manually, as can be seen in | Connecting rod |
| | | FIG. 1 (a). | between end |
| | | | effector and arm |
| | | | (AISI 4130 steel) |
| \textcircled{2} | Stereo camera(s) | Stereo cameras are attached to the | — |
| | | front and back side of the robot for | |
| | | navigation and path planning. | |
| \textcircled{3} | NDT Ultrasonic | Inspection equipment to identify | — |
| | Probe | material loss in an object through | |
| | | wall thickness measurement and | |
| | | evaluation. | |
| \textcircled{4} | PVC pipe(s) | Pipe(s) connecting the main robot | Polyvinyl |
| | | body to the tracks motor housing for | chloride (PVC) |
| | | heat transfer and to route track | |
| | | motor wires to the main circuit | |
| | | board/computer. | |
| \textcircled{5} | Tracks | Tracks for motion over 20-30 cm of | Tracks parts: |
| | | snow and uneven road surfaces. | Belt (Butyl |
| | | Tracks have various robot body | rubber) |
| | | mount levels to optimize stability | Links |
| | | and achieve the desired robot height. | (Aluminum 6061) |
| | | | Sprockets |
| | | | (316 L stainless |
| | | | steel) |
| \textcircled{6} | Robot base | Wheels and tracks are mounted to | Aluminum 6061 |
| | | the robot's base, and the rest of the | |
| | | robot's body is fixated on top of it. | |
| \textcircled{7} | Gearhead DC | Gearhead DC motor drives the | Motor housing |
| | motor(s) for | sprocket on the tracks, which leads | (IM7/77-2 |
| | tracks and motor | to the rotation of the track belt and, | carbon fiber) |
| | housing. | in turn, moves the robot | |
| | | forward/backward. | |
| \textcircled{8} | Robot body | The main body of the robot with | IM7/977-2 |
| | | batteries, a computer module, | carbon fiber. |
| | | heating/cooling hardware, stereo | Robot body |
| | | cameras, and other critical electronic | parts with |
| | | components. | camera's (Lexan |
| | | | Polycarbonate) |
| \textcircled{9} | External Table | Table for mounting external | ABS PC of |
| | | hardware components exposed to | Aluminum |
| | | the ambient air. | |
| \textcircled{10} | Vertical | Vertical supports with brackets | Vertical |
| | support(s) for the | connecting the external table to the | supports |
| | external table | robot base. | (Aluminum 6061) |
| | | | Brackets |
| | | | (ABS PC) |
| \textcircled{11} | Robot arm | Gearbox with a stepper motor to | Gearbox casing |
| | gearbox | actuate the robot arm rotation. | (IM7/977-2 |
| | | | carbon fiber) |
| \textcircled{12} | CCD camera | Inspection camera for capturing | — |
| | | visual information regarding an | |
| | | object like cracks, deformities, etc., | |
| | | and converting them into a high- | |
| | | quality digital image/video. | |
| \textcircled{13} | Inspection | Pan-tilt-zoom mechanism to rotate | Details in |
| | camera PTZ | the inspection camera in 3D space | section 3.1.4. |
| | mechanism | and align it with the object surface | |
| | | under scrutiny | |
| \textcircled{14} | PTZ system | A connecting rod to join the PTZ | AISI 4130 steel |
| | connector | camera rotation mechanism with the | |
| | | linear actuator using threaded ends. | |
| | | Linear actuator adjusts the height of | |
| | | the PTZ camera by up to 2″. | |
| \textcircled{15} | Electronics | A table with three stages on which | Aluminum 6061 |
| | mount table | the robot electronics, such as an | |
| | | embedded computer system, motor | |
| | | driver/controller, sensors, linear | |
| | | actuator, heating units, cooling fans, | |
| | | led lights, and other components, | |
| | | can be mounted. | |
| \textcircled{16} | Lithium-ion | Lithium-ion batteries supply power | Lithium-ion |
| | batteries | to the electrical framework of the | batteries casing |
| | | robot. | (Ni-coated steel) |
| \textcircled{17} | Lidar sensor | Lidar sensor for navigation, path | — |
| | | planning, and docking. Lidar can be | |
| | | used in conjunction with other | |
| | | sensors to achieve superior results in | |
| | | terms of autonomous docking and | |
| | | navigation. | |
| \textcircled{18} | Omni-wheel | Servo DC motor for wheels | Motor housing |
| | rotation motor | orientation in either the same | (IM7/977-2 |
| | and motor | direction to each other and in | carbon fiber) |
| | housing. | parallel to the robot base sides | |
| | | or 45° to the robot body, | |
| \textcircled{19} | Omni-wheels | Wheels that can be steered in | Tyre's (Butyl |
| | | various directions along the wheel | rubber) |
| | | axis. This wheel rotation | |
| | | functionality is useful for robot | |
| | | motion in tight spaces, such as | |
| | | inspection underneath a haul truck. | |
| \textcircled{20} | PVC pipe(s) | Pipe(s) connecting the motor | Polyvinyl |
| | | housing for the wheels to the main | chloride (PVC) |
| | | body for heat transfer and route | |
| | | motor wires to the main circuit | |
| | | board. | |
| \textcircled{21} | Wheel drive | A plate attached to the bottom side | Aluminum 6061 |
| | motor gearbox | of the robot base that holds the | |
| | plate | wheel drive motor gearbox. | |
| \textcircled{22} | Wheel drive | The gearbox consists of a DC motor | Motor and |
| | motor gearbox | to drive the wheel. The wheel is | gearbox housing |
| | | rotated in different orientations | (IM7/977-2 |
| | | along with the drive wheel motor | carbon fiber) |
| | | gearbox using the servo gearhead | |
| | | motor. | |
| \textcircled{23} | Vertical support | Vertical supports with brackets | Supports |
| | for motor | linking the wheel drive gearbox | (Aluminum 6061) |
| | gearbox plate | holder plate to the base of the robot. | Brackets |
| | | | (ABS PC) |
| \textcircled{24} | Stereo camera | Stereo cameras stand with vertical | Supports |
| | stand | supports and brackets for connection | (Aluminum 6061) |
| | | with the electronics mount table. | Brackets |
| | | | (ABS PC) |
| \textcircled{25} | Linear actuator | Stepper motor linear actuator for | — |
| | with actuator | precise height control of the robot | |
| | mount part | arm of PTZ mechanism. | |

The critical electro-mechanical components of an inspection robot can operate optimally only under a specified temperature range. Extreme high or low environmental temperatures may lead to the failure of these components on which the robot heavily relies and, thus, can cause disruption in its operation. According to some inventive embodiments, an inspection robot for extreme applications and environments is provided with a smart Fuzzy Logic temperature control system to adjust the internal temperature of the robot by either heating or cooling internal air to the desired temperature based on the feedback from a temperature sensor. Fuzzy Logic temperature control algorithms are executed using hardware components such as heating units, fans, and temperature sensors. This allows the inventive robot to adapt to extreme temperatures using minimal power consumption.

According to other inventive embodiments, a mobile inspection robot 100 for extreme temperature conditions includes a main body housing 8 defining at least one through opening 26 therein; a temperature sensor positioned within the main body housing and configured to determine an internal temperature within the main body housing; a thermal opening mechanism 30 positioned within the main body housing and configured to selectively open and close the at least one through opening in the main body housing; and a fuzzy logic temperature control system positioned within the main body housing and configured control the thermal opening mechanism to adjust the internal temperature of the robot by selectively heating and cooling internal air within the main body housing to a desired temperature based on feedback from the temperature sensor. Tubing is provided in fluid communication between the main body and the motor housing in order to modulate temperature in various parts of the robot through heat transfer. Tubing is denoted in the accompanying drawings with respect to reference numeral 4.

According to other inventive embodiments, the robot additionally includes a base frame 6 upon which the main body housing is supported. According to still other inventive embodiments, the critical electrical components of the robot are housed within the main body housing. According to still other inventive embodiments, the critical electrical components of the robot include at least one of a battery, a computer, a camera, thermal control devices, or a combination thereof. According to still other inventive embodiments, the main body is positioned at the center of the robot. According to still other inventive embodiments, the main body is cylindrical and/or is formed or carbon fiber, thereby providing high strength while offering a low weight.

According to other inventive embodiments, the robot additionally includes at least one fan 34 mounted to a wall within the main body housing and controlled by the fuzzy logic temperature control system. According to still other inventive embodiments, the at least one fan is positioned opposite to the at least one through opening 26 in the main body housing. According to still other inventive embodiments, the robot additionally includes a heater 36 positioned within the main body housing and controlled by the fuzzy logic temperature control system. According to still other inventive embodiments, the thermal opening mechanism is configured to be actuated by the fuzzy logic temperature control system to automatically open at least one through opening in the main body housing when the temperature sensor indicates that the internal temperature of the robot exceeds a set threshold.

According to other inventive embodiments, the thermal opening mechanism comprises a stepper motor 38, a rotating plate 40, and a shaft 42 on which the rotating plate is affixed. According to still other inventive embodiments, the rotating plate 40 defines a plurality of holes 44 at a perimeter thereof that cooperate with a plurality of rivets 46 that are positioned around a perimeter of the at least one through opening in the main body housing. According to still other inventive embodiments, a spur 48 and a worm gear 50 are used in conjunction with the stepper motor to achieve a desired torque and rotation speed of the plate. According to still other inventive embodiments, the rotating plate is configured to rotate up to 90° from a resting position.

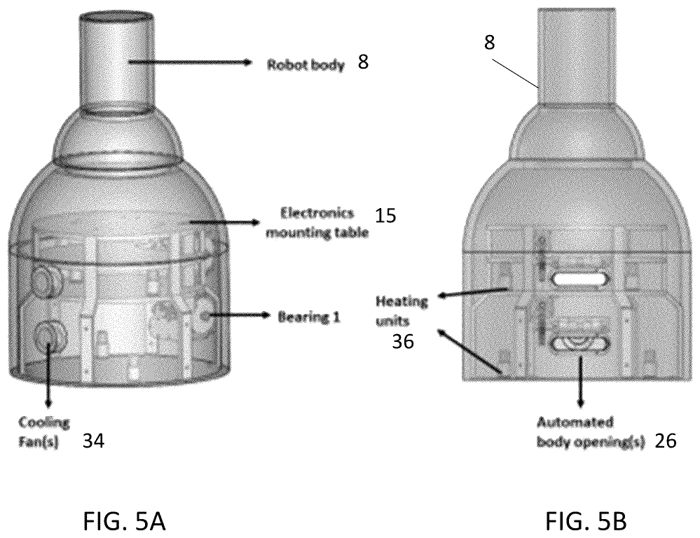

FIGS. 5A and 5B illustrate an embodiment of an inventive robot body and its internal hardware components, such as cooling fans, heating units, and the mechanical design for thermal openings. The thermal openings inside the robot body permit excess heat to escape the body in case of electronics overheating or if the internal temperature goes above the set limit. Two thermal openings are shown in the robot design on the wall opposite the mounted fans in FIG. 5B; however, according to some inventive embodiments, more openings are provided on the walls perpendicular to the fans to quicken the cooling process. According to some still other inventive embodiments, additional fans are provided in other locations on the robot like the robot arm gearbox subassembly, stereo cameras, PTZ subassembly, and motors for the tracks and the wheels to prevent them from overheating. The thermal openings are motorized and are configured to be unlocked automatically based on the robot's internal temperature sensor feedback.

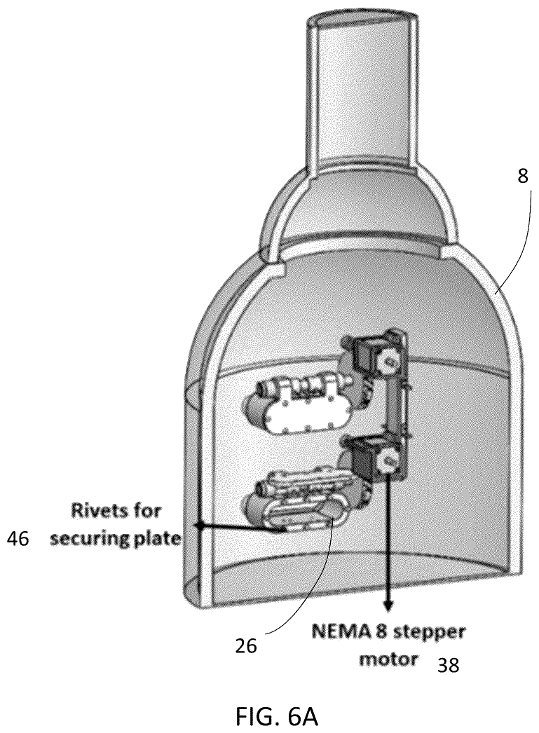

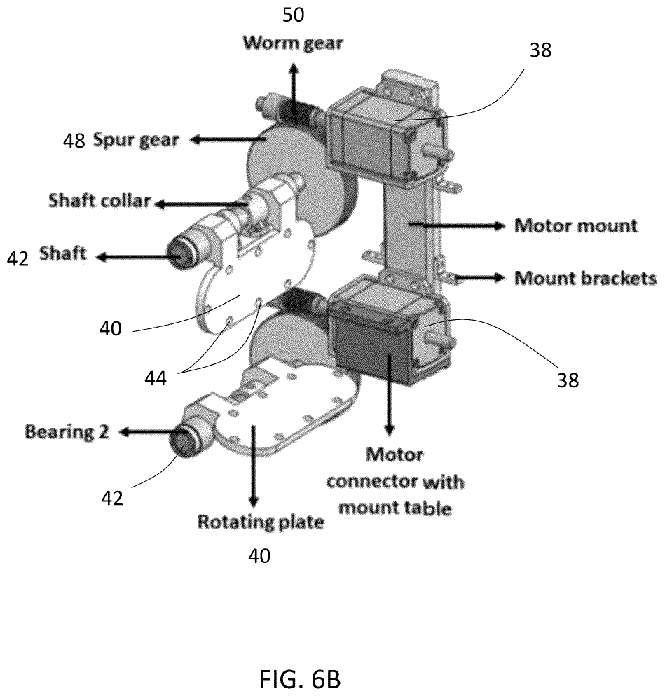

FIGS. 6A and 6B show the design overview of the thermal opening mechanism, including a stepper motor, a rotating plate with holes, and a shaft/rod on which the rotating plate is affixed. A cylindrical shape with rivets on its thin-profiled face can either be manufactured along with the robot body or separately and later can be attached to the wall, and it could either be the same material as the robot body or different. These tube-shaped rivets are there to secure the plate when the openings are closed. Shaft collars secure the shaft to the cylindrical-shaped profile width. Moreover, the stepper motors are fixed to a vertical motor mount attached to the electronics mount table, as indicated in FIG. 6B. A spur and a worm gear are used with the stepper motor due to the limited available space to achieve the desired torque and rotation speed of the plate.

According to some inventive embodiments, a stepper motor is used for the thermal openings for the precise positioning of the rotating plate. The plate can rotate up to 90° from the resting position (thermal opening closed). The stepper motor specifications, like the rotor moment of inertia, motor steps, holding torque, and stepper motor speed, are shown in Table II. Moreover, the acceleration torque can be calculated using the load inertia (JL), the gear ratio (i), and the positioning time of the motor (t1), which is also shown in Table II. A desired rotational speed of 60°/s, a safety factor of 2, and positioning time of 0.55 s, the desired rotational speed for the rotating plate, the acceleration torque (Ta), and the motor torque (TM) are evaluated which can be seen from Table II. Due to the available space inside the robot body, the smallest stepper motor, NEMA 8, is chosen, which has the highest speed, and thus, the gear ratio between the motor speed and the desired speed is quite large with an approximate value of 167; thus, a worm/spur gear combination would be an appropriate choice for such configuration.

TABLE II
Stepper motor for thermal openings input and output parameters

| | | |
|---|---|---|
| Input | Stepper motor steps | 360°/1.8° = 200 |
| | J₀ [kgm²] | 1.829 × 10⁻⁷ |
| | Max/holding torque [Nm] | 3.307 |
| | Stepper motor speed [rpm] | 3300 |
| | J_{L} [kgm²] | 1.549 × 10⁻⁵ |
| | t₁[s] | 0.55 |
| | T_{L} [Nm] | 2.007 × 10⁻³ |
| | SF | 2 |
| Output | Nₘ [rpm] | 18 |
| | i | 3000/18~167 |
| | Tₐ [Nm] | 0.0175 |
| | T_{M} [Nm] | 0.0389 |

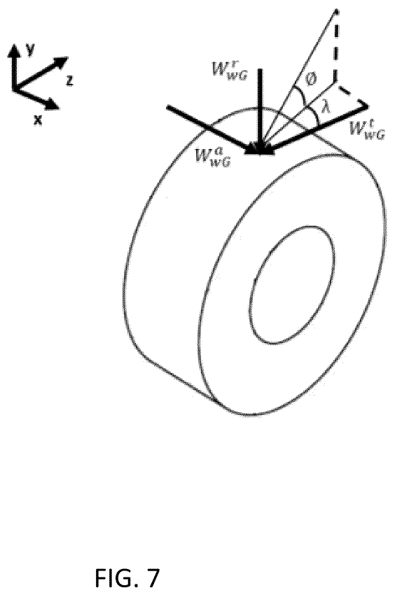

FIG. 7 demonstrates the radial, tangential, and axial forces exerted by the worm gear on the spur gear during shaft rotation. The spur gear of 167 teeth is in mesh with a worm gear, which can be thought to have one tooth that engages with the spur gear once for each rotation, analogous to a screw rotation with a lead angle. Thus, λ in FIG. 7 represents the lead angle of the worm gear, and ϕ denotes the pressure angle of the spur gear.

Based on the FBD in FIG. 7, the equations for calculating the tangential (W_{wG}^{t}), radial (W_{wG}^{T}), and axial (W_{wG}^{a}) components of the gear force on the shaft can be derived as equations 1 to 4. Where, T is the torque supplied by the motor and r_{G} is the pitch radius of the spur gear mounted on the rotating shaft.

$$T = {W}_{wG}^{t} {r}_{G} \qquad Equation 1$$

$${W}_{wG}^{a} = {W}_{wG} cos ϕ sin λ \qquad Equation 2$$

$${W}_{wG}^{t} = {W}_{wG} cos ϕ cos λ \qquad Equation 3$$

$${W}_{wG}^{r} = {W}_{wG} sin ϕ \qquad Equation 4$$

The lead angle can be determined using equation 5, where dₚ is the pitch diameter of the spur gear. The pitch radius, pressure angle, lead angle, and the three components (tangential, axial, and radial) evaluated using equations 2 to 4 can be viewed in Table III.

$$tan λ = \frac{l}{π {d}_{p}} \qquad Equation 5$$

TABLE III
Spur gear design specifications, the weight of the rotating
plate, worm gear lead angle, and the tangential, radial,
and axial forces on the rotating shaft

| | |
|---|---|
| r_{G} | 20.58 |
| ϕ | 20 |
| m_{rotatingplate} | 0.00778 |
| F_{rotatingplate} | 0.0763 |
| λ | 0.345 |
| W_{wG}^{t} | 1.89 |
| W_{wG}^{a} | 0.0114 |
| W_{wG}^{r} | 0.688 |

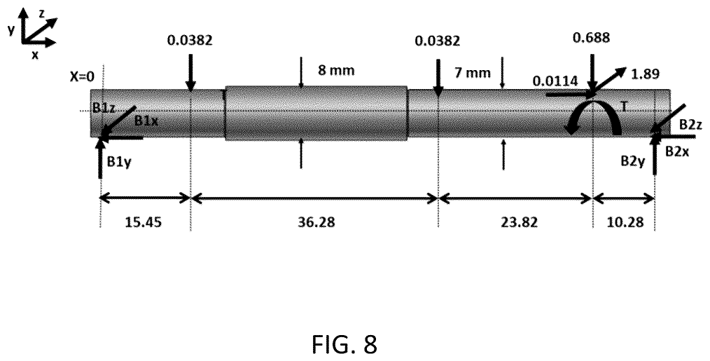

The thermal opening rotating shaft with all the forces due to gear and bearings as well as the torsional force are shown in FIG. 8. Moreover, the location of the forces on the shaft and the thickness of different cross-sectional areas of the shaft are also shown in FIG. 8. The weight of the rotating plate mounted on the shaft is shown in Table III and is also included in the shaft FBD in FIG. 8 at the two contact points between the rotating plate and the shaft.

The reaction forces in the x-y and x-z plane due to bearings 1 and 2 are obtained by the summation of moments at one of the bearings in the y and z directions. The reaction forces due to the bearings in the x-y and x-z plane on the thermal opening shaft can be observed in Table IV.

TABLE IV
Reaction forces due to bearings in the x, y,
and z directions on the thermal opening shaft

| | | | |
|---|---|---|---|
| B1y [N] | 0.130 | B1 [N] | 0.264 |
| B1z [N] | 0.230 | | |
| B1x [N] | ~0.0057 | | |
| B2y [N] | 0.640 | B2 [N] | 1.779 |
| B2z [N] | 1.660 | | |
| B2x [N] | ~0.0057 | | |

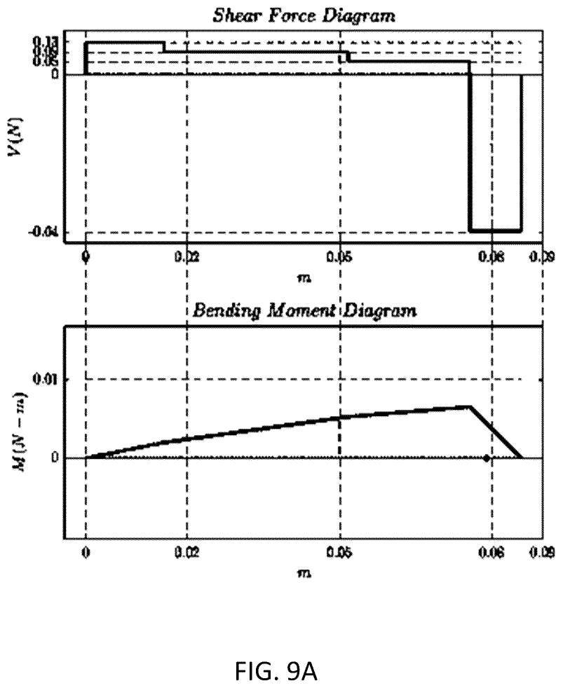

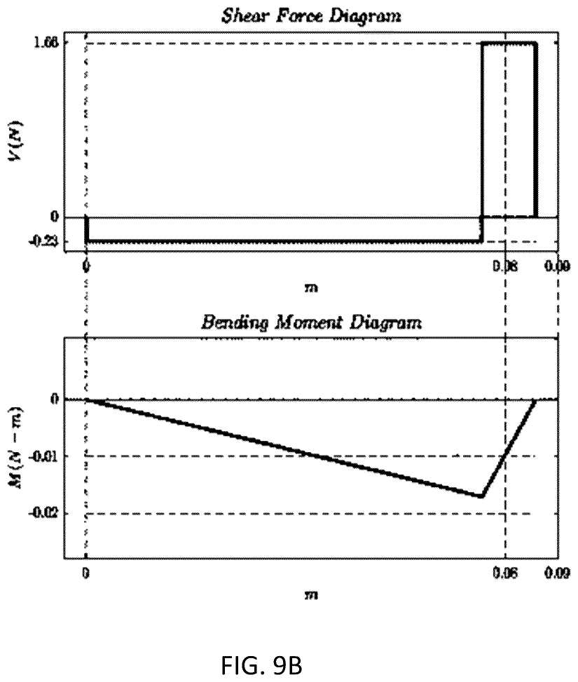

The shear force and bending moment diagrams due to the radial forces on the thermal opening shaft in the x-y and x-z plane are shown in FIGS. 9A and 9B, respectively. Moreover, the maximum shear forces and bending moments in the x-y and x-z planes are shown in Table V.

TABLE V
Maximum shear stress and bending moment values
for the thermal shaft in the x-y and x-z plane.

| | |
|---|---|
| Maximum shear force in x-y [N] | −0.64 |
| Maximum shear force in x-z [N] | 1.66 |
| Maximum Bending in x-y [Nm] | 0.008 |
| Maximum Bending in x-z [Nm] | −0.015 |

Since the bearing reaction forces and the maximum shear and bending moments are extremely low, it can be assumed that the shaft design will operate safely and effectively under the applied load conditions.

According to some inventive embodiments, the robot includes an embedded computer and electronic system for running the robot and providing power to the thermal system described above. According to other inventive embodiments, a high-performance computer, NVIDIA Jetson module is used to process data and communicate with all the electronic devices integrated with the robot such as sensors, stereo navigation camera's, CCD inspection camera(s), NDT equipment, fans/heating units, motors for the tracks, omni-wheels, robot arm, and PTZ mechanism. Moreover, it serves as a mediator to establish connections between different devices. NVIDIA is a commonly used computing module for robotic systems that require high speed, power efficiency, and a wide range of storage space. Moreover, it has an embedded AI computing device to support deep learning, computer vision, and multi-media processing applications. Furthermore, it can be linked to the Wi-Fi modem to facilitate wireless communication between internal and external hardware devices.

According to some inventive embodiments, temperature and humidity sensors are used throughout the robot body to monitor the internal air temperature and humidity as a safety feature. Suppose the set limits for the internal body temperature or humidity levels are crossed. In that case, the robot will act automatically and instantaneously by changing the speed of the heating/cooling equipment and actuating the thermal opening inside the robot body, as described earlier.

According to some inventive embodiments, the estimate power consumption and amp hours for the above described thermal system of the inventive robot include Fan: alternating current multifan operating at 12 V, with 1 to 50 cubic feet per minute (cfm) having a power consumption of 0.1 to 5 W and (0.01 to 5)×4 ampere hours (AH) as well as a cartridge heater having a power consumption of 50-60 W and 2.2×6 AH. This is based on an assumption that the operation time for the robot is one hour; thus, amp hours are calculated based on the total amperage consumed by the electronics in one hour.

Batteries are the primary power source for the robot to keep it functioning autonomously and for extended periods. According to some inventive embodiments, the inventive robot is fitted with lithium-ion batteries as they have high capacities and are lightweight. Table VI shows the Lithium-ion battery specifications used for the mobile robotic platforms, like the nominal voltage, capacity, dimensions, and mass.

TABLE VI
Panasonic Lithium-ion battery cell specification
Panasonic Lithium-ion batteries

| | |
|---|---|
| Nominal Voltage [V] | 3.6 |
| Dimensions [mm] | 18.63 *65.08 |
| Mass [kg] | 47.5 |
| Capacity [mAH] | 3400 |

According to some inventive embodiments, the Fuzzy Logic temperature control system is used to adjust the temperature of the robot, which allows the robot to operate at extreme low temperatures such as −40° C. and as high as 50° C. Moreover, there are outlets for the cooling setup of the robot. These openings remain closed during the heating process. The apertures/openings open automatically using a motorized mechanism based on the temperature reading from the sensors.

The thermal openings inside the robot body permit excess heat to escape the body when internal temperature increases.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A mobile inspection robot for extreme environment conditions, the robot comprising:
a main body housing defining at least one through opening therein;
a temperature sensor positioned within the main body housing and configured to determine an internal temperature within the main body housing;
a thermal opening mechanism positioned within the main body housing and configured to selectively open and close the at least one through opening in the main body housing; and
a fuzzy logic temperature control system configured to control the thermal opening mechanism to adjust the internal temperature of the robot by selectively heating or cooling internal air within the main body housing to a preselected temperature based on feedback from the temperature sensor.

2. The robot of claim 1 further comprising a base frame upon which the main body housing is supported.

3. The robot of claim 1 wherein a plurality of critical electrical components of the robot are housed within the main body housing.

4. The robot of claim 3 wherein the plurality of critical electrical components of the robot include at least one of a battery, a computer, a camera, thermal control devices, or a combination thereof.

5. The robot of claim 1 wherein the main body is positioned at the center of the robot.

6. The robot of claim 1 wherein the main body is cylindrical.

7. The robot of claim 1 wherein the main body is formed of carbon fiber.

8. The robot of claim 1 further comprising at least one fan mounted to a wall within the main body housing and controlled by the fuzzy logic temperature control system.

9. The robot of claim 8 wherein the at least one fan is positioned opposite to the at least one through opening in the main body housing.

10. The robot of claim 9 wherein the at least one fan is an alternating current multifan operating at 12 Volts and 1 to 50 cubic feet per minute.

11. The robot of claim 9 wherein the at least one fan has a low power consumption of 0.1 to 5 W and (0.01 to 5)×4 ampere hours.

12. The robot of claim 1 further comprising a humidity sensor positioned within the main body housing and configured to determine an internal humidity within the main body housing.

13. The robot of claim 1 further comprising a heater positioned within the main body housing and controlled by the fuzzy logic temperature control system.

14. The robot of claim 13 wherein the heater is a cartridge heater, has a low power consumption of about 50-60 W and 2.2×6 ampere hours, or a combination thereof.

15. The robot of claim 1 wherein the thermal opening mechanism is configured to be actuated by the fuzzy logic temperature control system to automatically open at least one through opening in the main body housing when the temperature sensor indicates that the internal temperature of the robot exceeds a set threshold.

16. The robot of claim 1 wherein the thermal opening mechanism comprises a stepper motor, a rotating plate, and a shaft on which the rotating plate is affixed.

17. The robot of claim 16 wherein the rotating plate defines a plurality of holes at a perimeter thereof that cooperate with a plurality of rivets that are positioned around a perimeter of the at least one through opening in the main body housing.

18. The robot of claim 16 further comprising a spur and a worm gear used in conjunction with the stepper motor to achieve a desired torque and rotation speed of the plate.

19. The robot of claim 16 wherein the rotating plate is configured to rotate up to 90° from a resting position.

20. A method of extreme environment mobile inspection comprising:
operating the robot of claim 1 in the extreme environment; and
communicating information about the extreme environment to a location remote therefrom.
